(19) United States
(12) Patent Application Publication
(10) Pub. No.: US 2014/0123982 A1
(43) Pub. Date: May 8, 2014

(54) Nostril Filtration Assembly

(71) Applicant: Raymond G. Maddock, 73 Honniball Street (AU)

(72) Inventor: Raymond G. Maddock, 73 Honniball Street (AU)

(21) Appl. No.: 13/943,923

(22) Filed: Jul. 17, 2013

Related U.S. Application Data
(60) Provisional application No. 61/723,485, filed on Nov. 7, 2012.

(51) Int. Cl. A62B 23/06

(52) U.S. Cl. CPC A62B 23/06
USPC 128/206.11

(57) ABSTRACT

The present invention relates to an airborne filtration assembly that is clipped onto the exterior of the nose and comprises filters to cover the nostrils. The nasal filtration assembly comprises a plurality of interchangeable pieces including that of decorative nose clips, disposable filters, and replaceable nose pads. The assembly functions by catching and trapping airborne particles and protects the nostrils from pollen, dust, germs, bacteria, and second hand smoke. The disposable filtration patches come in unscented or in a variety of pleasing scents, and are contained within hingedly attached mesh containers that cover and provide protection of the nostril of the area. The entire frame, along with device accessories, can be stored in a hard plastic carrying case for easy access.

### CROSS REFERENCE TO RELATED APPLICATION

This application claims the benefit of U.S. Provisional Application No. 61/723,485 filed on Nov. 17, 2012, entitled “MIAIR PURGE.” The above identified patent application is herein incorporated by reference in its entirety to provide continuity of disclosure.

### BACKGROUND OF THE INVENTION

1. Field of the Invention

The present invention relates to disposable nose filters that protect against airborne pathogens. More specifically the present invention relates to a nostril filter insertable within a nose clip.

Many people experience reactions of the immune system when exposed to unhealthy environments. This can occur in outdoor environments, work environments, in a public transportation setting, and even in a home environment. These environments may harbor virulents, bacteria, pollen, smoke, dust mites and other germs that cause a reaction when ingested by an individual. When exposed to these environmental allergens, the immune system may try to rid itself of the allergens by initiating sneezing or coughing, and increasing mucus production in the nostrils. Inhalation of these allergens can also lead to asthmatic symptoms, caused by the narrowing of the airways and a production of mucus that creates a shortness of breath and wheezing and coughing.

Surgical masks are the traditional solution for protection against airborne pathogens and are used by the general public in highly populated areas to prevent the transfer of germs and illnesses. The use of surgical masks reached its height of use during viral outbreaks such as that of the SARS virus, swine flu, and bird flu. The masks are used to both contain a sickness to the user, while also preventing others from being exposed to the sickness to a non-wearer. There are those, however, who do not want to make it public that they are sick, or do not want to appear that they are avoiding those who may have an illness. Surgical masks are quite conspicuous in their deployment and generally give off a negative impression associated with the reason for its use

Additionally, surgical masks are inconvenient because they cover a majority of a person's face. They are not capable of constant protection because they must be removed during eating. Furthermore, they interfere with one's make-up and they promote sweating by the covering of a large area of the face.

There are several devices that attempt to provide a solution to the drawbacks of wearing a surgical mask. These devices come in the form of nasal filtration assemblies that provide the protection offered by filtration masks but without the bulkiness and negative presentation that accompanies a complete nose and mouth covering. The drawback of these filter assemblies is that they rely on tape-like adhesives to provide a securing mechanism between the nostril and filtration device. The use of these assemblies can be problematic in that they are often uncomfortably secured by insertion inside of the nostril and lack adjustable assemblies to suit individual nostril diameters.

A further drawback of most nostril covers is that existing devices fail to provide an attachment assembly that incorporates disposable filtration disks. The use of static systems is problematic because different situations and environments might require different filtration materials to suit the environmental threat. A customizable and interchangeable filtration assembly that provides the user with protection from airborne pollutants is desired.

The present invention relates to a new and improved airborne filtration assembly that is non-invasively clipped onto the exterior of the nose and is designed to cover the nostrils. Specifically, a nostril filtration assembly is provided that comprises disposable filters that catch and trap airborne particles that cause allergies, viruses, and infections by protecting people from pollen, dust and dust mites, germs, bacteria, and second hand smoke. The disposable filtration patches come in original or medicated scents and are inserted within hingedly attached mesh containers that cover and provide protection of the nostril of the area. In situations where the mesh lacks in the complete coverage of the nasal opening, there are optional clear membranes that snap into place on the frame of the assembly to seal the remaining unprotected nasal passage. The filtration assembly also comprises interchangeable nosepiece spring clips offered in a variety of colors and designs to suit a user's style.

2. Description of the Prior Art

Devices have been disclosed in the prior art that relate to airborne filtration assemblies. These include devices that have been patented and published in patent application publications. These devices generally relate to nostril filtration assemblies that fail to provide customizability to suit a user's needs or style. The following is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 2,777,442 to Zelano teaches a nasal filter comprising a jeweled nose clip on opposite sides of the filter, creating an attractively ornamented device. The jewels additionally serve to provide an increased bearing area against the surface of the nose to aid in securely gripping the nose. The Zelano filter, however, differs from the present invention in that it is inserted within the nostril canal, and therefore fails to provide comfort for the user.

U.S. Pat. No. 5,890,491 to Rimkus describes a disposable nose filter to be inserted into a nostril. When inserted in the nasal passage the filter becomes fixedly attached by an adhesive component on the housing or on a flange that seals the lower exterior portion of the nostril, and forces air through the filter and not between the filter housing and the nostril canal. The Rimkus disposable nose filter provides a filter that comprises a flexible housing for insertion within the nasal canal and further comprises a sealing flange to cover the remaining portion of the nasal canal.

Additionally, Rimkus describes another disposable nose filter in U.S. Patent Application Publication No. 2004/0261798. The publication is similar to that patent of Rimkus, however the publication differs in that the filter comprises an interconnecting component between the nostril filters that prevent the filters from moving too far within the nasal cavity.

Although the Rimkus filters are similar in nature and relevant to the present invention, the Rimkus filters differ in that they fail to provide a customizable fit to accommodate a variety of nostril canal diameters or to offer customized aesthetic design options.

U.S. Pat. No. 8,110,061 to Moore teaches a respiratory nasal filter sized to the periphery of a user's nasal orifice. The filter is made of a woven fiber to help prohibit the inhalant of foreign pollutants, pollens, poisons, viruses and other airborne containments and further comprises a clear adhesive layer for adhere to the periphery of the user's nostril. The Moore filter, however, differs from the present invention in that it fails to provide a customizable fit to accommodate a variety of nostril canal diameters.

U.S. Patent Application Publication No. 2002/0166556 to Jacob describes a nose filter for airborne solids and pathogens. The filter comprises a flexible plastic spring having that connects on the nose in a U-shaped configuration. Attached to the spring material is a length of filter material that lies under and is in substantial contact with the nose and permits the filtering of airborne containments. While the Jacob filter is similar in nature and relevant to the present invention, it differs in that the filter assembly fails to provide interchangeable attachments and customizable design options.

The present invention relates to a nasal filtration assembly that is clipped onto the exterior of the nose and is designed to cover the nostrils. The assembly comprises disposable filter patches that come in original or medicated scents. A hinged mesh attached to the frame of the assembly covers the nasal opening and contains the disposable filters. In situations where the mesh lacks in the complete coverage of the nasal opening, there are optional clear membranes that snap into place on the frame of the assembly to seal the remaining unprotected nasal passage. The filtration assembly further comprises interchangeable nosepiece spring clips offered in a variety of colors and designs to suit a user's style.

In view of the aforementioned drawbacks of the prior art, it is shown that the present invention substantially diverges in design elements from the prior art and consequently it is clear that there is a need in the art for an improvement to existing nasal filtration devices. In this regard the instant invention substantially fulfills these needs.

### SUMMARY OF THE INVENTION

In view of the foregoing disadvantages inherent in the known types of airborne filtration assemblies now present in the prior art, the present invention provides a new nasal filtration assembly wherein the assembly can be utilized for providing convenience for the user when customizability of the filter and assembly frame is desired.

It is therefore an object of the present invention to provide a new and improved nasal filtration assembly that has all of the advantages of the prior art and none of the disadvantages.

It is another object of the present invention to provide a nasal filtration assembly comprising disposable filter disks.

Another object of the present invention is to provide an assembly comprising scented filtration disks.

Yet another object of the present invention is to provide an assembly comprising interchangeable nose clips.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the parts of the preferred embodiment of the nasal filtration assembly.

FIG. 2 illustrates a perspective view of the frangible membrane of the present invention.

FIG. 3 shows a view of the nasal filtration assembly of the present invention in use.

FIG. 4 shows a perspective view of the present invention in a carrying case.

### DETAILED DESCRIPTION OF THE INVENTION

Reference is made herein to the attached drawings. Like reference numerals are used throughout the drawings to depict like or similar elements of the nasal filtration assembly. For the purposes of presenting a brief and clear description of the present invention, the preferred embodiment will be discussed as used for a customizable nasal filtration assembly. The figures are intended for representative purposes only and should not be considered to be limiting in any respect.

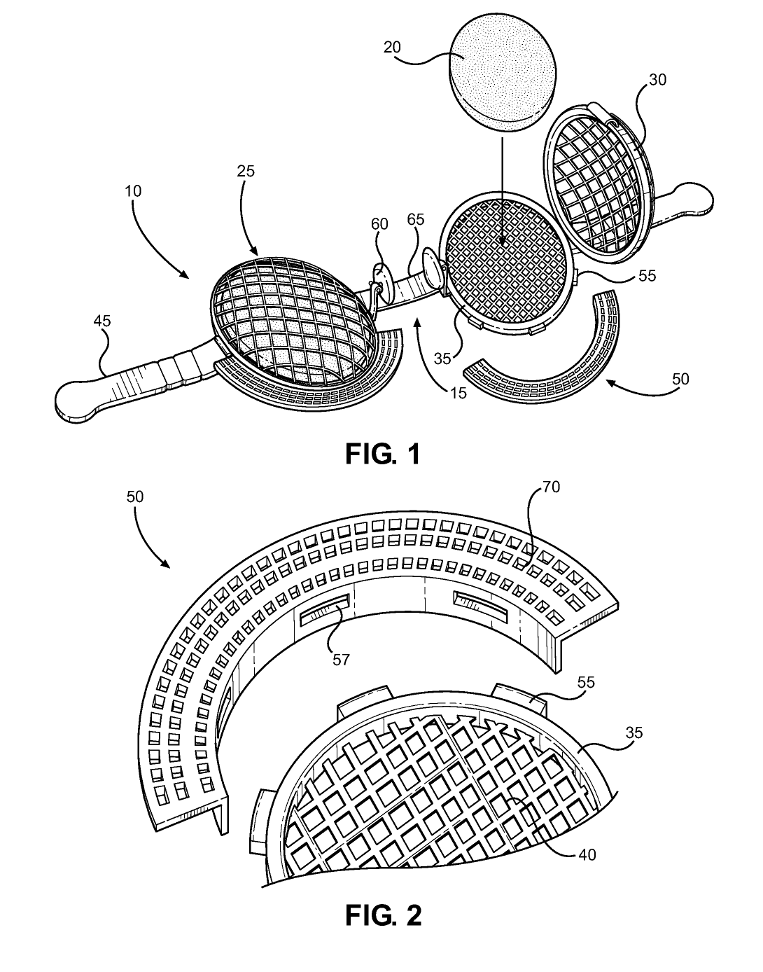

Referring now to FIG. 1, there is shown a perspective view of the nasal filtration assembly 10 of the present invention. The frame 15 of the assembly 10 can be made of a thin metallic material or other suitably flexible material and is adapted to be wrapped around the lower nostril to provide filtration. The frame 15 is comprised of a set of circular hinged holders 25, nose clips 45, nose pads 60, and a central flexible bridge portion 65.

The holders 25 are comprised of a static section 35 and an outer hingedly movable section 30 that is configured to be clamped at an area opposite the hinge thereof. The holder sections each comprise open-air mesh screens 40 of differing gauges pressed into each of the inner and outer holder frames and are configured to contain the disposable filters 20 therein. The inner mesh is of a smaller gauge as it holds the filter between the two meshes. When the filter 20 is inserted between the two holder sections, the sections are clipped closed and the filter 20 is secured between the two sections.

In an alternative embodiment of the present invention, the screens 40 can have folded edges that are pressed and secured into the outer edges of the frame of the holders 25. Furthermore, the meshes 40 may be soldered or otherwise permanently secured to the inner edges of the holders 25, thus providing a clean and more aesthetic appearance for the user.

On either inner portion of the frame 15 are spring-closing nose clips 45 that curvable inward to hug the sides of the nose when bent. The clips 45 become secured to the lateral sides of the nose and hold the hinged filter holders 25 in place just under the nostril canals to enable proper filtration of air entering the nose. To suit the style of the user, the clips 45 are interchangeable and are offered in a variety of colors and designs, and may be provided with small gemstones or other accessories.

Between outer nose clips is a flexible central bridge portion 65 that is designed to be bent slightly and create a secure fitting around the nasal septum as it is clamped under the front of the nose. The central bridge 65 is preferably a flexible strap that supports interchangeable nose pads 60 that clamp onto the septum of the nostril canal and aid in the placement of the assembly 10.

The filters 20 of the present invention can be detached from the assembly and replaced as needed without needing to dispose of the entire assembly. The filters 20 are formed of a semi-permeable material, and are configured to catch and trap airborne particles that cause allergies, viruses, and infections by protecting people from pollen, dust, germs, bacteria, and second hand smoke. The filters are made from strands of non-compressed, micro-thin fibers, such as biodegradable plant fibers and/or synthetic fibers. Furthermore, when these fibers are dampened with medicated or fragranced oils, they keep their form and are not limited in their ability to capture any contaminates that attempt to enter the nostril area; as opposed to generic filters which can clog when impregnated with oils.

To prevent any unfiltered airborne contaminants reaching the nostrils of the user, the filters are formed into shapes that provide a snug fit within the holders 30. The filter patches 20 may be waterproof and are offered in original or medicated scents including that of tea tree oil, eucalyptus oil, and non-fragrant oils.

The filters 20 are configured to provide a fitting with the frame of the mesh holders 25, however, if the frame 25 does not fully accommodate the nostril canal, the frame 25 comprises attachments configured to seal the unprotected opening.

Referring to FIG. 2, the assembly comprises a detachable set of clear nonporous membranes 50 configured to seal a remaining area that remains unfiltered. The membranes comprise connecting ports and are curved to correspond with a perimeter of the circular frame. The membrane is secured at the connection ports 57 to a set of three notches 55 on the frame assembly 15 and is frangible to provide a proper fitting for individual needs.

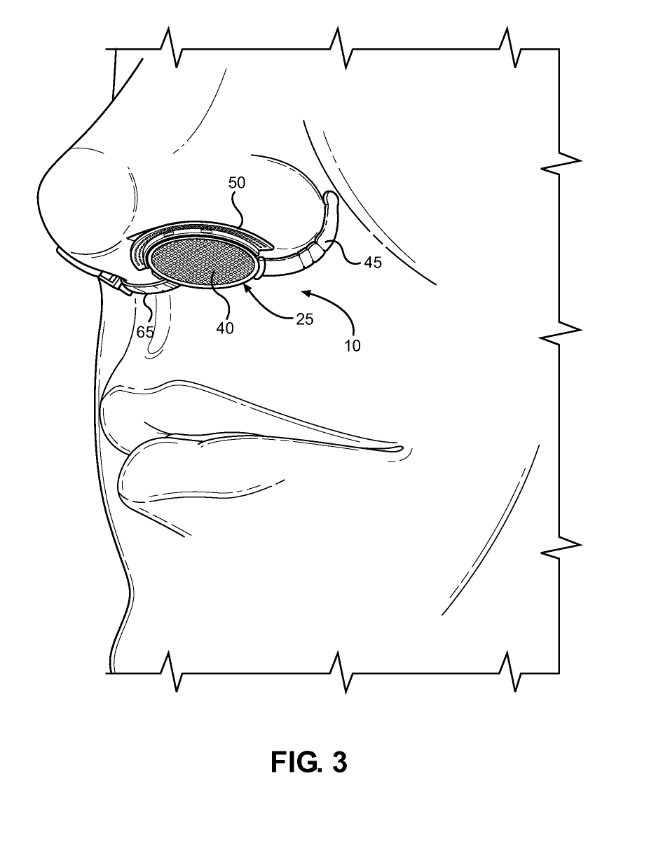

Referring to FIG. 3, there is shown a close up view of the present invention of FIG. 1 while in use. The assembly is comprised of a set of circular hinged holders 25, nose clips 45, nose pads 60, circular filters 20, frangible membranes 50, and a central flexible portion 65. For proper use, the hinged holders 25 are unclamped and opened for insertion of a filter 20. The filters 20 are sized to occupy the entire holder area and can be one or more of original or medicated scents including that of tea tree oil, eucalyptus oil, and non-fragrant oil filter types. The holder 25 is closed and seals the filter between the static 35 and hinged ends 30 of the mesh holders 25 and the assembly 10 is placed underneath the nose.

Next the interchangeable nose clips 45 are selected from a plurality of clip designs, including that of a variety of colors and decorative attachments and the nose clips are attached or detached from the assembly by a small screwdriver. The central bridge 65 of the frame 15 is then placed beneath the nose and is bent slightly to curve around the columella while the nose pads 60 are gently pressed against the septum of the nostrils. Once gently secured on the nose, the spring-clips 45 are bent and curved around the lateral sides (wings) of the nose and the filter 20 is secured in place beneath the nostrils.

If the filter 20 fails to fully cover the nostril opening, there are attachments that provide for the complete coverage of the nasal canal. The frame 15 comprises a set of three notches 55 on a lower portion of the static half 35 of the holder 25, and the clear membrane 50 of the assembly 10 comprises a corresponding set of ports 57 for attachment to the notches 55. The nonporous membrane 50 is snapped onto the notches 55 of the static holder 35 and further comprises an adhesive to seal around the external periphery of the nasal canal to seal the unfiltered portions of the canal. The membrane 50 comes in one preset size, but includes cutting guidelines 70 (FIG. 2) for sizing the membrane 50 to individual needs. When sized correctly, the membrane 50 blocks air coming through the nostril opening and the assembly ensures that only filtered air is capable of entering the nostril canal.

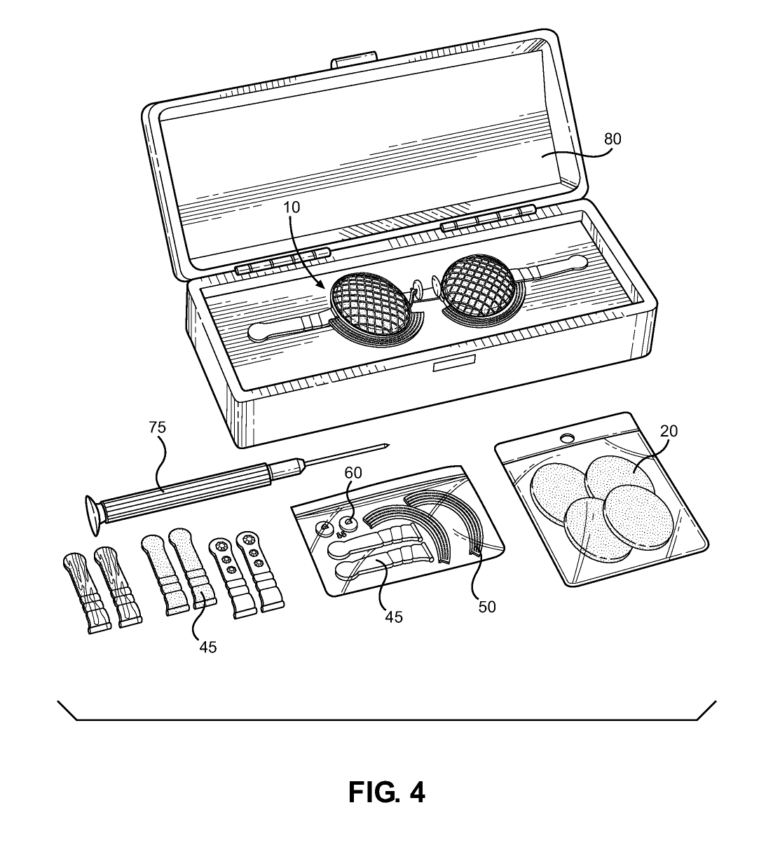

The assembly comprises detachable and interchangeable nose pads 60, nose clips 45, and filters 20 and depending on the environment, different accessories may be called upon at different times. FIG. 4 displays a hard plastic carrying case 80 for the filtration assembly 10 and its plurality of accessories and a screwdriver 75. The case 80 comprises space for the frame 15, including the holders 25, central strap 65, and nose clips 45, as well as the plurality interchangeable scented or medicated filters 20, nose clips 45, nose pads 60, and sealing membranes 50. It is within the scope of the invention to provide a carrying case that is comprised of wood, metals, or any suitable material for providing a secure container.

The case 80 is compact enough to be easily carried within a pocket or a small bag and allows the user to change the accessories to match the occasion. Examples include the use of scented filters 20 to mask or enhance the smells of the environment, and a variety of nose clip 45 attachments to match the user's clothing, glasses, skin tone, or mood at the time.

The present invention provides an improved assembly for nostril filtration and includes a plurality of interchangeable accessories, including that of interchangeable nose pads 60, sealing membranes 50, nose clips 45, and filters 20. The filter patches 20 may be waterproof and are offered in original or medicated scents including that of tea tree oil, eucalyptus oil, and non-fragrant oils to suit the environment that the user is within. The assembly 10 is provided with interchangeable nose clips 45 to increase the aesthetic appearance of the assembly and the user. The plurality of nose clips 45 can be provided in a variety of colors and designs, as well as a multitude of accessories on the clips 45, including that of small gems, jewels, and engravings. When the accessories and optional membrane membrane 50 extension is selected, the filtration assembly 10 is fit onto the nose of the user by to curving the central strap around the columella. The pads 60 extending from the central strap 65 are gently press against either side of the nasal septum and the nasal clips 45 hug the lateral sides of the nostril to secure the assembly 10 to the nose. The assembly 10 then provides filtration of the nostril and only filtered air is capable of entering the nasal canal opening.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A filter assembly that filters air entering the nasal canal, comprising:
a frame having a pair of filter holders, a first and second nose clip, and a central bridge region between said filter holders;
said filter holders comprising a first static holder section and a second hinged clamping section, said holder section and said clamping section being mesh screens adapted to sandwich a filter element therebetween;
said filter holders adapted to be placed against a wearer's nostrils and said first and second nose clips adapted to be bent around the lateral sides of the nose.

2) The device of claim 1, further comprising at least one membrane attachable to said filter holder, wherein said member is adapted to provide extended coverage over a nostril opening.

3) The device of claim 2, wherein said at least one membrane further comprises construction adapted to conform to the perimeter of said filter holders and secure thereto.

4) The device of claim 2, wherein said at least one membrane comprises a frangible construction to allow for altering its extended size from said filter holder.

5) The assembly of claim 1, wherein the central bridge is adapted to curve around the septum.

6) The assembly of claim 1, wherein the nose clips are removable and interchangeable.

7) The assembly of claim 4, wherein the interchangeable nose clips comprises one or more of a variety of colors, designs, engravings and gem accessories.

8) The device of claim 1, wherein said filter holders comprise rounded structures having a perimeter edge, a hinged attachment between said filter holder static holder section and hinged clamping section, and at least one notch attachment means to secure said static holder section to said hinged clamping section.
